(19) United States
(12) Patent Application Publication
(10) Pub. No.: US 2013/0013727 A1
(43) Pub. Date: Jan. 10, 2013

(54) SYSTEM AND METHOD FOR PROVIDING A MOBILE PERSONA ENVIRONMENT

(76) Inventor: Robin Edward Walker, Alax (CA)

(21) Appl. No.: 13/176,232

(22) Filed: Jul. 5, 2011

(51) Int. Cl. G06F 15/16; G06F 17/30

(52) U.S. Cl. 709/217

(57) ABSTRACT

A system and method are disclosed for providing a mobile persona environment hosted by a network accessible server that can be activated by network connected client device. The client device points the portion of its file system used by the operating system to configure the desktop environment to a persona container hosted by the server. The persona container includes user data, applications and operating system settings or policies that are used to configure the operating system of the client device to provide the mobile persona environment. The client device obtains user profile information and connection information from a persona reference object stored on the client device. Applications are executed locally on the client device while the data remains secure in the network accessible server.

### FIELD

The present disclosure relates generally to a system and method for providing a mobile persona environment.

### BACKGROUND

Virtual desktop infrastructure is often used in enterprise environments to provide secure data and applications to a mobile workforce. A desktop operating system or applications are hosted within a virtual machine running on a centralized server that is provided over a network to a remote client machine. This infrastructure requires significant processing power and memory at the centralized server to run the virtual machine. The remote client also requires continuous network access to the centralized server.

Virtual desktop infrastructure is expensive to implement and maintain. Implementing virtual desktop infrastructure with solutions from Citrix or VMWare require at least a gigabyte of memory per user and substantial server processing power. The server costs create a large capital expenditure to implement a virtual desktop solution with additional data center operating costs. Additional software licenses are another cost of providing a virtual desktop infrastructure. Providing a remote client machine to mobile workers can also be a substantial cost.

Since applications are executed on the central server, virtual desktop infrastructure allows a mobile user to access the system from a thin client with limited hardware. Although, more commonly, the mobile worker is accessing this infrastructure using a hardware device that is sufficiently powerful and more cost efficient than server hardware, such as consumer-grade laptops, desktops or tablet computers, and potentially smart phones. Server hardware also typically does not include a graphics processor and has difficulty executing graphical applications, especially those including real time graphics, high definition video or audio. Voice over IP and video conferencing applications are particularly problematic since the audio and video must be routed to and from the remote client machine.

Providing applications natively on a client hardware device with a graphics processor can provide an improved user experience, productivity and functionality but typically sacrifices the data security benefits of a virtual desktop infrastructure. If a client machine is lost, stolen or suffers a hard drive failure, confidential data can be vulnerable. Encryption can be implemented on the client machine to secure data but this degrades performance of the client machine and, in some cases, may be disabled by the user.

Another option is to deliver the entire virtual machine image and data to the client device over a network connection. This approach takes advantage of the processing power of the client device but also suffers from potential data security issues. A large amount of bandwidth is required to deliver an operating system image or an application image making this approach infeasible for most practical applications.

Other client-server infrastructure provides an authentication server, such as LDAP, open directory or Kerberos, to provide a network login in combination with a network home directory. The network home directory contains all the users personal data and application settings and is typically stored on an network accessible file system, such as NFS or AFP. Network home directories and the associated infrastructure must be configured by an administrator before a user can access their account. External connections to other file servers must be routed through the network home directory server.

### SUMMARY

Accordingly, there is a need to provide a more cost efficient mobile desktop with improved performance over virtual desktop infrastructure while retaining the data security and management aspects of virtual desktop infrastructure.

According to a first aspect, a method for accessing a mobile persona environment on a client device is provided, the client device has an operating system and a file system for storing persona environment data. The method comprises accessing a persona reference object to obtain a pointer to a persona container on a network connected server, the persona container having persona environment data; pointing a portion of the persona environment data of the file system to the persona container of the network connected server identified by the pointer; and directing the operating system to access network connected server to activate the mobile persona environment. In a further aspect, the method comprises accessing the persona reference object to obtain one or more network source pointers corresponding to one or more network sources; and pointing a portion of the file system to the one or more network source pointers.

According to another aspect, a client device for accessing a mobile persona environment is provided where the client device has an operating system having a file system for storing persona environment data that defines the mobile persona environment, including applications, settings and user data; mobile persona application for accessing a persona reference object to obtain a pointer to a persona container on a network connected server, the persona container having persona environment data, the mobile persona application pointing the persona environment data of the file system to the persona container of the network connected server, and the mobile persona application directing the operating system to access network connected server to activate the mobile persona environment; and a processor and memory for executing and storing instructions of the operating system and mobile persona application.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a block diagram of a system for providing a mobile desktop environment;

FIG. 2 is a block diagram of a system for providing a mobile persona environment to a client device connected by communication network to persona server;

FIG. 3 is a block diagram of an embodiment of a client device illustrating mobile persona application executing on operating system to access client device hardware 306 in order to provide a mobile persona environment; and

FIG. 4 is a block diagram of an embodiment of a persona server illustrating a persona delivery module providing access to persona container through a persona virtual machine executing on a virtualization layer on server device hardware.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

The embodiments of the systems, devices and methods described herein may be implemented in hardware or software, or a combination of both. Some of the embodiments described herein may be implemented in computer programs executing on programmable computing devices, each computing device comprises at least one processor, a computer memory (including volatile and non-volatile memory), at least one input device, and at least one output device. Program code may operate on input data to perform the functions described herein and generate output data.

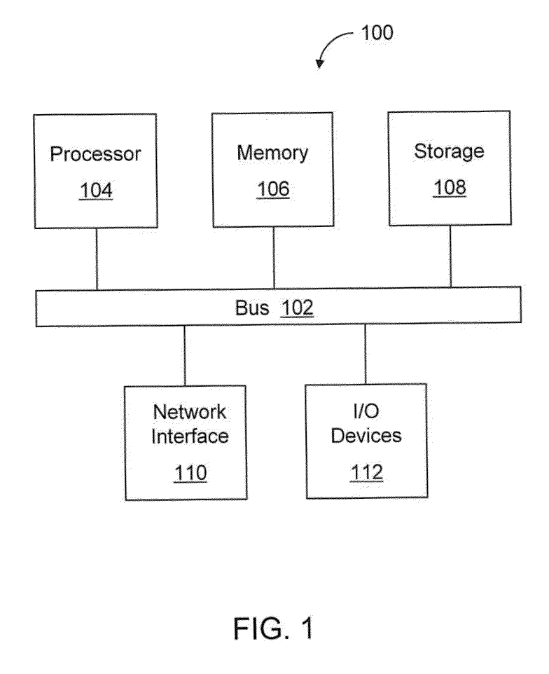

FIG. 1 is a block diagram of an embodiment of computing device 100. Computing device 100 can represent a range of computing devices (either wired or wireless), including, for example, a desktop computer, a server, a laptop computer, a cellular telephone, a tablet computer or a set-top box. Some computing devices can include more, fewer or alternative components to those shown in FIG. 1.

Computing device 100 can include bus 102 to connect processor 104 to other components. While computing device 100 is illustrated with a single processor, computing device 100 can include multiple processors, and in some instances, application specific processors, such as a graphics processing unit in a desktop or laptop computer. Computing device 100 can further include memory 106 connected to bus 102 for storing information and instructions that can be executed by processor 104. Memory 106 that can be implemented as volatile memory, such as, for example, random access memory.

Computing device 100 can further include storage 108 coupled to bus 102 that provides persistent storage of information and instructions. Storage 108 can be implemented as a magnetic disk, flash memory or other non-volatile memory as is known in the art. Storage 108 and memory 106 can store applications and data, including an operating system that interacts with the various components of computing device 100.

Computing device 100 can further include network interface 110 coupled to bus 102 to provide access to a communication network. Network interface 110 can be wired or wireless and support any of a number of protocols or standards, such as, for example, any of the various IEEE 802.11 standards, cellular communication standards, and personal area network standards.

Computing device 100 can further include any number of additional input/output (I/O) devices 112 coupled to bus 102. I/O devices 112 can include user input devices, such as, for example, a keyboard, a mouse, or a touch screen interface. I/O devices 112 can also include a display device to provide information to a user, such as liquid crystal display.

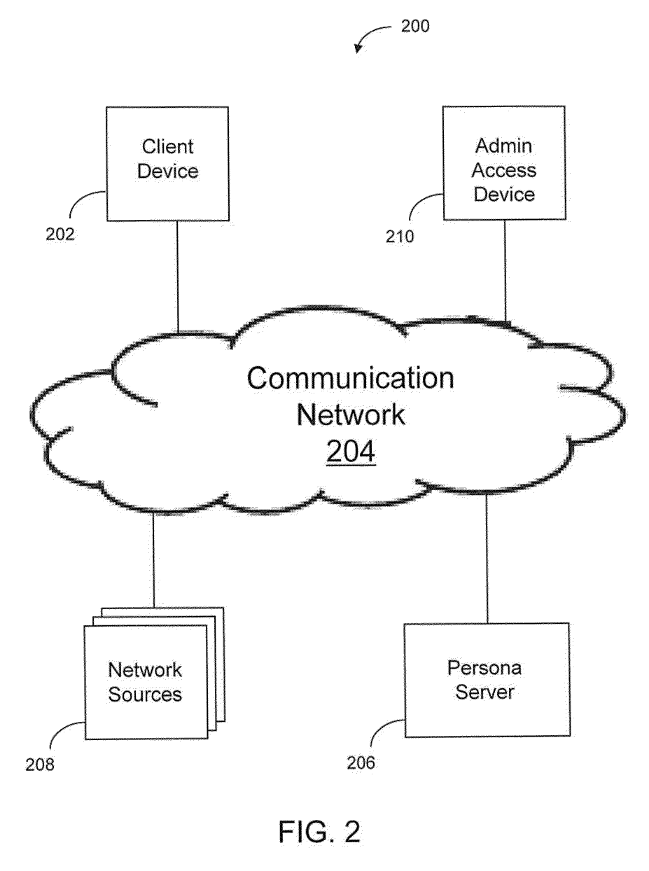

FIG. 2 is a block diagram of a system 200 for providing a mobile persona environment to a client device 202 connected by communication network 204 to persona server 206. Client device 202 can authenticate with persona server 206 to access a persona container hosted by persona server 206. Persona container hosted by persona server 206 can contain policy settings, applications and user data that comprise part of the mobile persona environment of client device 202. By hosting persona containers on persona server 206, any client device 202 is capable of accessing a mobile persona environment by connecting through network 204 to persona server 206. Persona containers are configured to be agnostic to the particular hardware of client device 202 such that a user could switch to another client device 202 yet still access the same mobile persona environment.

A mobile persona environment is a personalized desktop including applications and data provided by persona server 206 and/or network sources 208. The persona environment can include the customized aspects of the graphical user interface running on client device 202, such as look-and-feel aspects or IT policy constraints. In a Unix-based operating system, a mobile persona environment can include the user's home directory that includes application settings and user data, such as documents or media files. By providing access to mobile persona environment available from network-connected persona server 206, a user is able to access their applications and data from any client device connected to network 204 and have the operating system of client device 202 provide the same user experience. Since the persona containers only contain those aspects needed to create the mobile persona environment on client device 202, the persona containers are much smaller in size compared traditional virtual machine images for an operating system instance and also require less computing device resources to host since the operating system and applications are executing on client device 202 rather than a virtual infrastructure.

Communication network 204 can be a private or public data network, or a combination thereof and can also include a public internet. Communication network 204 can also include one or more local area networks (LAN) coupled to form a private wide area network (WAN). For example, a LAN can be implemented using Ethernet networking technology. The WAN can be a private network physically scaled to cover a geographic area sufficient to join private LANs. LAN and WAN technology can include both wired and wireless communications.

Client device 202 can also be configured to access network sources 208. Network sources 208 can include a directory or volume that resides on a remote computing device and is made available to client device 202 over communication network 204 using a network protocol, including but not limited to Apple Filing Protocol (AFP), Samba (SMB/CIFS), secure file transfer protocol (sFTP) or network file system protocol (NFS).

Administrative access device 210 accesses an administrative interface to administer persona server 206. Administrative access device 210 can be used by an administrator to manage persona containers hosted by persona server 206. Administrative access device 210 can be a computing device, similar to client device 202, that executes an administrative software application that connects through network 204 to persona server 206 in order to provide the administrative interface. Alternatively, administrative interface can be provided through a web browser executed by administrative access device 210 to connect to a web accessible administrative interface provided by persona server 206 that can be accessed over communication network 204.

The administration interface allows an administrator to setup persona containers, either individually or for multiple users, and configure persona containers on persona server 206. Using the administrative interface provided by administrative access device 210, an administrator can also add or delete persona containers, modify user privileges, reset passwords, specify disk quotas, account expiry dates and operating system policies. Aspects of a users mobile desktop environment can be reset or modified, either individually or for multiple users, to allow an administrator to provide appropriate data, applications and user settings.

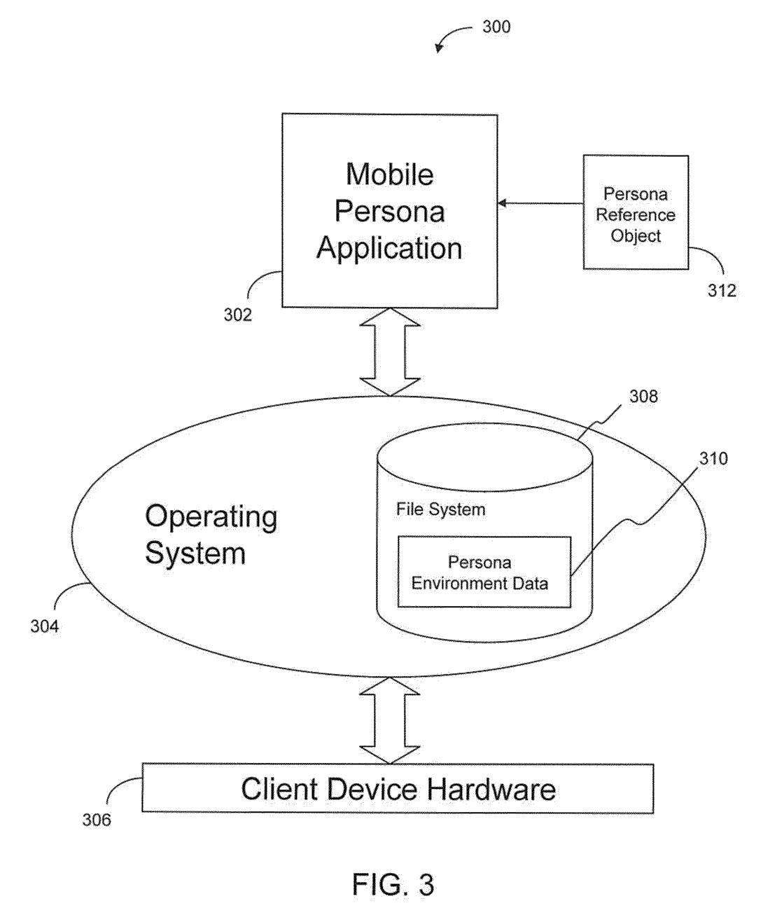

Reference is next made to FIG. 3, shown is a block diagram of an embodiment of a client device 300 illustrating mobile persona application 302 executing on operating system 304 to access client device hardware 306. Client device hardware 306 can include any variation of components making up computing device 100 shown in FIG. 1 but typically includes a display for presenting a graphical user interface of operating system 304, and some type of input device for interacting with the graphical user interface, such as, for example, a keyboard and pointing device.

Operating system 304 can be stored in memory of client device hardware 306 and executed by a processor of client device hardware 306. Operating system 304 can be multi-user, multiprocessing, multitasking, multithreading, real time, or include any other known variation and features of a computer operating system. Operating system 304 can be any Windows, Mac OS, Unix or Linux variants. Operating system 304 provides access to storage of client device hardware 306 through file system 308 as is known in the art. Operating system 304 typically organizes file system 308 to include a file and directory structure that separates operating system data, applications and user data.

Persona environment data 310 can comprise a user's operating system settings, applications, and data. Settings can includes look-and-feel aspects of the GUI of operating system 304, policy settings, and preferred settings for the user's applications. Persona environment data 310 can further include a user's home directory that contains applications, application settings and data that is protected by the file system 308 permissions to only be accessible by the user or an administrator of client device 300.

In a traditional multi-user operating system, persona environment data 310 is stored in file system 308 on local client device 300 for each of the users. When a user accesses client device 300, typically on login, operating system 304 activates user environment data 310 to provide the user's desktop environment. Storing persona environment data 310 on client device 300 means that the user's desktop environment can only be accessed from that particular client device 300.

Mobile persona application 302 provides a mobile persona environment that can be accessed from any client device 300 connected to communication network 204. Mobile persona application 302 connects to a network accessible server, such as persona server 206 shown in FIG. 2, to provide persona environment data 310 to operating system 304. The connection is typically made over a secure network link, such as SSL for example. Mobile persona application 302 accesses persona reference object 312 to obtain connection details that directs mobile persona application 302 to point portions of persona environment data 310 of file system 308 to an appropriate persona container hosted by persona server 206. Persona reference object 312 also contains connection details to other network sources 208 that can direct client application 302 to point other portions of user environment data 310 to network sources 208.

By pointing persona environment data 310 to a network connected server, operating system 304 obtains data from persona server 206 and network sources 208 on an as-needed basis. This speeds up login times and makes efficient use of network bandwidth since data, applications and settings reside on the network connected servers until needed. Also, the size of user environment data 310 is not limited by the capacity of storage of client device hardware 306. Unlike traditional virtual desktop infrastructure, applications execute locally using client device hardware 306 rather than a central server. Client device hardware 306 typically includes a graphical processing unit and can provide improved performance in graphics intensive applications and an improved user experience due to the responsiveness of the locally executed application.

Client application 302 can aggregate multiple network sources 208 and persona server 206 by pointing user environment data 310 to these other servers to provide a mobile desktop environment that unifies data from multiple network sources 208.

Persona reference object 312 stores network information for the persona server 206 and network sources 208 and user profile information necessary for client application 302 to generate the user's mobile desktop environment. Network information can include network addresses, connection protocol and authentication information. Persona reference object 312 can also store network information for a redundant or backup persona server 206 in case the primary persona server 206 is unavailable. Connection details can further include expiration date information for each specified network connection that can be validated by client application 302 prior to connecting to persona server 206 or network sources 208. User profile information stored in persona reference object 312 can include user account information that is used by operating system 304 to create a mobile persona environment, such as, for example, a user name and user group. User profile information can also include policy data used by operating system 304 to control aspects of mobile persona environment. For example, an embodiment of persona reference object 312 can contain MCX control data that can be used by Apple's Mac OS X operating system to set parental controls, such deactivating applications or services, and configure the look-and-feel of the Mac OS X graphical user interface, among other things. Persona reference object 312 can also include an expiration date that can be used to disable access to the mobile persona environment.

Persona reference object 312 can be an encrypted data file or plain text file, such as XML, with encrypted portions, that mobile persona application 302 decrypts upon receiving correct credentials input from a user. Data within persona reference object 312 that can be altered is typically encrypted using symmetric encryption, such as, for example, AES-256 bit encryption, whereas internally used keys can be stored using cryptographic hash sums, such as, for example, MD5 hash sums and SHA512 hash sums. Mobile persona application 302 can use encryption and decryption libraries provided by operating system 304 or other commonly available libraries, such as OpenSSL and the Common Cryptography framework.

Mobile persona application 302 can be implemented as a launch daemon or login script that configures file system 308 of operating system 304 to point to persona server 206 and network sources 208 upon login. When mobile persona application is invoked, persona reference object 312 is decrypted with user supplied credentials to obtain the network information for persona server 206. Mobile persona application 302 then assess the availability of persona server 206, and if available, authenticates with persona server 206. Network information for additional network sources 208 is also checked for validity against any expiration dates and availability of network sources 208.

Persona reference object 312 contains a persona identifier that corresponds to a particular persona container hosted by persona server 206. Mobile persona application 302 then mounts portions of the identified persona container to portions of file system 308. For each of the valid network sources 208, mobile application makes a new connection to each of network sources 208.

Mobile persona application 302 can also direct temporary cache directory of file system 308 to client device 300 rather than persona server 206 to improve performance and reduce network congestion. Not repeatedly transferring temporary files between client device 300 and persona server 206 tends to be faster and offers improved application stability. Temporary cache directories can be stored on persona server 206 or any of network sources 208, but are typically only synchronized periodically or during session starts or termination.

An exemplary login process will now be provided to illustrate how mobile persona environment is provided on client device hardware 306 by mobile persona application 302. As a first step, persona reference object 312 is verified by mobile persona application 302 with a user-supplied password or PIN. This can be performed using an SHA-512 hash check with authentication data stored in persona reference object 312. Mobile application 302 can also retrieve user profile information, including login and administrator information (e.g. administrator login credentials), from persona reference object 312 that can be decrypted using MD5 hashed keys and AES-256 bit values. The retrieved login information can then be verified with operating system 304, such as, for example, performing a console login in a Unix-based operating system. Rather than authenticating for network access, mobile application 302 provides authentication to access the persona reference object 312 and to access the user and/or administrator accounts of operating system 304.

Mobile persona application 302 can also verify network connectivity with persona server 206 using a network address obtained from persona reference object 312. User profile information obtained from persona reference object 312 can be used to configure desktop environment of the operating system 304. Alternatively, user profile information can be retrieved from persona server 206 that can be used to supplement or replace user profile information obtained from persona reference object 312. For example, mobile persona application 302 can generate an MCX profile for the user of the mobile desktop environment and apply it to the local operating system 304. User profile information can be used to control access to local resources (e.g. applications, preferences, and directories) and the resources of client device hardware 306 (e.g. hard disk, cameras, optical drives, disc recording, and removable media). User profile information can also control access to the active home directory.

Persona reference object 312 can contain administrator login credentials when an IT administrator manages the local client device 300. This is referred to as a partially authorized persona reference object 312. Mobile persona application 302 will attempt to find valid administrator credentials embedded within persona reference object 312, and, if located, mobile persona application 302 will then retrieve a unique identifier of client device hardware 306 (e.g. UUID, MAC address, etc.) and embed it in persona reference object 312. Persona reference object 312 is then considered fully authorized and is locked to client device hardware 306.

Mobile persona environment can also be provided on client device hardware 306 that is not managed by an IT administrator. For example, a user may want to use their personal computer to access their mobile persona environment where the user actually has administrator privileges over client device 300. In this case, mobile persona application 302 would not find valid administrator credentials (since they are only known to the user) and would request that these be provided by the user. Persona reference object 312 can be considered wholly unauthorized if it does not contain valid administrator credentials. Once mobile persona application 302 is provided with administrator credentials, the administrator credentials along with a unique identifier of client device hardware 306 can be used to fully authorize persona reference object 312. The user profile information used to configure operating system 304 can then be used to limit a user's access to settings of mobile persona environment even though the user may own and administer the computer. Even if a user did tamper with user profile or policy settings, these would be restored at the next login either from persona reference object 312 or persona server 206.

The benefit to an IT administrator of using partially authorized or unauthorized persona reference objects is that they can provide secure access to any device without managing client device 300. For example, a school IT administrator can create a generic unauthorized persona reference object 312. Students can then take that generic unauthorized persona reference object 312 and mobile persona application 302 to any client device 300 and recreate their full mobile persona environment (provided that the administrator of client device 300 is willing to authorize persona reference object 312 with the student's credentials).

As part of the exemplary login process, mobile persona application 302 can also configure file system 308 so that persona environment data 310 points to a persona container on persona server 206. Mobile persona application 302 can configure the file system 308 so that the home directory for the user profile is a mount point for the persona container. For example, in a Unix-based operating system the home directory location for the user (e.g. /Users/UserProfile) can be directed to the mount point (e.g. /Volumes/UserProfile). Next, mobile persona application 302 points the mount point for the persona container to the persona container hosted by persona server 206, such as, for example, by mounting the persona container at the mount point using the Unix mount command. Other network sources 208 can be similarly pointed to by aspects of file system 308 based on expiration information stored in persona reference object 312. The mount points of network sources 208 on file system 308 can be linked to the users home directory in persona container stored on persona server 206. For example, a symbolic link to the mount point of connected network sources 208 in the local file system 308 can be placed in the user's home directory stored in the persona container hosted by persona server 208. Mobile persona application 302 can manage access to network sources and persona container by removing expired links, forcing a dismount of expired network sources, and restricting permissions to file system 308. The file cache directory portion of the user's home directory can be redirected to the local file system 308, and can be synced on login and logout, or periodically, with persona server 206.

Mobile persona application 302 generates instructions for mounting directories locally and dynamically on client device 300. For example, mobile persona application 302 can actively test for certain criteria, such as, for example, host availability and expiration dates, and then generate the appropriate instructions for mounting a directory. Each mounted directory can be a separate process that mobile persona application 302 can then monitor.

The exemplary login process can initiate the mobile desktop environment on local client device hardware 306 by initiating a user switch via operating system 304. Using Apple's Mac OS as an example, mobile persona application 302 can initiate the mobile desktop environment by initiating a user session using the user profile information obtained from persona reference object 312 and/or persona server 206 and activating fast user switching. The CGSession binary can initiate the fast user switch by identifying the configured user profile and, if required, a Mac OS security agent process can be used to configure a password for the user profile. Upon login, the user will be presented with their mobile desktop environment such that their data and applications are stored on persona server 206 or network sources 208, but applications and operating system code are all executed by local client device hardware 306.

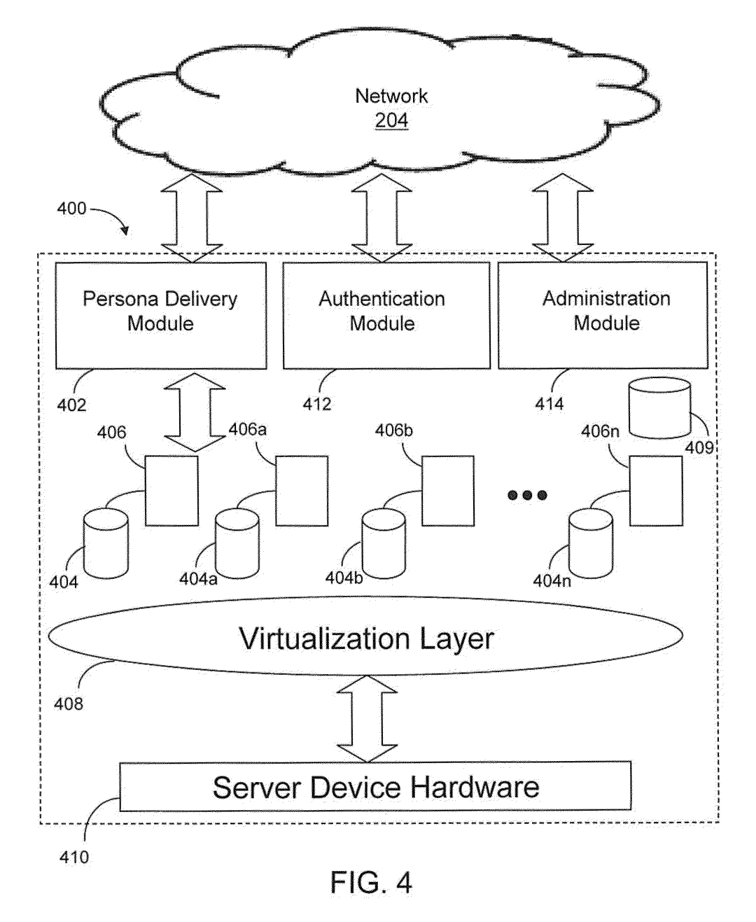

Reference is next made to FIG. 4, shown is a block diagram of an embodiment of persona server 400 illustrating persona delivery module 402 providing access to persona container 404 through persona virtual machine 406 executing on virtualization layer 408 on server device hardware 410. Server device hardware 410 can include a number of commodity servers, storage and network devices. Server device hardware 410 typically includes a number of multiprocessor servers that provides a pool of resources for dynamic scheduling by virtualization layer 408. Backup and disaster recovery solutions can also be included in server device hardware 410. Additional persona containers 404a-n and persona virtual machines 406a-n are also shown.

Virtualization layer 408 provides flexibility to move around workloads and eliminates any dependence on any specific component of server device hardware 410. Virtualization layer 408 typically includes a hypervisor to manage multiple persona virtual machines 406 to share the virtualized hardware resource of service device hardware 410. Examples of virtualization layer 408 can include, but is not limited to, VMWare ESX, Citrix XenServer or Microsoft HyperV.

Persona virtual machine 406 is a virtual appliance that can quickly be instantiated on virtualization layer 408. The main function of persona virtual machine 406 is to provide and manage access to persona container 404. Persona virtual machine 406 can include web servers that are used to access a user profile database 409 to provide user profile information to mobile persona application 302, as described above. User profile database can include user policy settings (e.g. MCX settings used to generate an MCX account profile a Mac OS).

Persona virtual machine 406 requires far fewer resources than traditional Virtual Desktop Infrastructure (VDI) that provides a full virtual desktop or application virtualization to network clients. For example, server device hardware 410 would typically require 1 GB of RAM per user and sufficient processor power to operate a traditional virtual desktop or virtual application whereas persona virtual machine 406 requires under 10 MB of RAM and substantially less processing power since the operating system and applications are executed locally on client device 300. This results in substantial hardware savings and reduced data center costs in deploying mobile persona environments compared to traditional VDI. For 1,000 users, traditional VDI solutions require 20-25 quad/quad servers and more than two racks in a data centre. Since mobile persona desktops require under 10 MB of RAM per user, a deployment of 1,000 users would require only two dual/quad servers and only one-fifth of a rack in a data centre. At a savings of approximately $2,000 per user over three years, in a deployment of 1,000 users this translates into $2,000,000 in savings. Executing applications locally on client device 300 also provides an improved user experience since application response does not depend on network latencies. Also, the graphical processing unit of client device 300 can be used to improve performance of graphically intensive programs to allow for marked performance improvement over VDI and allow for the use of multimedia and VoIP applications. This performance improvement is provided while maintaining data security similar to VDI by centrally storing and managing user data.

Persona container 404 encapsulates and isolates elements of a mobile persona environment to make them more manageable, user-centric, mobile and secure. Persona container 404 includes settings, IT policies, applications and user data that comprise a user's mobile persona environment. By centralizing storage of the mobile persona environment, loss of a client device 300 does not result in a loss of data or security since the user's desktop remains on the server.

Persona container 404 can be implemented as a virtual machine disk file, such as, for example, a VMDK file. This allows persona server 400 to use existing virtual disk management tools and provides for simple backup and redundancy of persona container 404. Encapsulating a mobile persona desktop using virtual machine tools allows the workload associated with serving persona container 404 to be moved around with the ease of copying a file. This also allows for consolidation, business continuity, rapid provisioning, data center automation, and disaster recovery.

Authentication module 412 is a directory service that authenticates requests from client devices 300 with data stored in the directory. Authentication module 412 can include LDAP/X.500 based directory services. Authenticated client device requests are provided to persona delivery module 402 that connects the appropriate client device 300 to the appropriate persona virtual machine 406 serving persona container 404. Persona delivery module 402 can then provide requested data to client devices 300 over a secure connection, typically secured using SSL.

In some embodiments, client devices 300 can access user data stored in persona container 404 over a WebDAV connection rather than activating the mobile persona environment on client device 300. This provides an alternate method for users to access their documents stored persona server 400 when client device 300 does not have an operating system that is capable of implementing the mobile persona environment, such as a smart phone or tablet computer.

Administration module 414 provides an interface for an administrator to manage persona server 400 and persona container 404. A secure connection is made between administration module 414 and administrative access device 210 used by an administrator. Administration module 414 allows for mobile persona environment management functions that can include creating, deleting, enabling and disabling users, changing passwords, setting user and group disk quotas, and modifying account-expiration dates. These operations can be achieved by administration module 414 adding, deleting or modifying persona containers 404 or user profile database 409. Administration module 414 can also create, modify and distribute persona reference objects 312 that are used by client devices 300 to access a mobile persona environment. Management and delivery of mobile persona environments represented by persona containers 404 and persona reference objects 312 can be achieved through the integration of administrative access device 210 with scripts executing on persona server 206.

Administration module 414 can manipulate data stored in persona container 404 to modify mobile persona environments. For example, administration module 414 can reset a mobile persona environment to a default state. Data can also be pushed to a mobile persona environment in order to provide all users or a group of users with access to certain files. For example, in a school setting, administration module 414 can modify persona container 404 of all student enrolled in a certain class to provide class material to the student mobile persona environment that is presented in a consistent way across all students mobile persona environments. Administration module 414 can also enforce IT policy by either modifying persona container 404 or modifying user profile information by redistributing persona reference objects 312 or altering user profile database 409.

Administration module 414 can also provide for rapid provisioning of mobile persona environments that is much quicker than provisioning a desktop environment on a client device. For example, in a campus setting with over a thousand students starting on a single day, administration module 414 is able to rapidly provision mobile persona environment for each student by creating persona environment containers and distributing persona reference objects to the students in a single day. Compare this to provisioning each individual physical client device at 15 minutes each illustrates the administrative efficiency of implementing mobile desktop environments with persona server 400.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A method for accessing a mobile persona environment on a client device, the client device having an operating system and a file system for storing persona environment data, the method comprising:
accessing a persona reference object to obtain a pointer to a persona container on a network connected server, the persona container having persona environment data;
pointing a portion of the persona environment data of the file system to the persona container of the network connected server identified by the pointer; and
directing the operating system to access network connected server to activate the mobile persona environment.

2. The method of claim 1 further comprising:
accessing the persona reference object to obtain one or more network source pointers corresponding to one or more network sources; and
pointing a portion of the file system to the one or more network source pointers.

3. The method of claim 1 wherein the persona reference object contains expiry data for any one of the mobile persona environment, the persona reference object and at least one of the one or more network sources, the method further comprising checking the expiry data prior to pointing the file system.

4. The method of claim 3 wherein the pointer comprises network information including network protocol and authentication information.

5. The method claim 4 wherein pointing the file system comprises mounting a network accessible file system to the file system of the client device.

6. The method of claim 1 wherein the persona reference object contains user profile information that is used to configure a second portion of the persona environment data of the file system.

7. The method of claim 6 wherein directing the operating system to activate the mobile persona environment occurs at login to the operating system of a user profile identified by the user profile information.

8. The method of claim 6 further comprising setting user file permissions of the file system to allow access by a user profile identified by the user profile information.

9. The method of claim 6 wherein user profile information includes operating system policy constraints that limit the function of the operating system for the identified user.

10. The method of claim 1 further comprising decrypting the persona reference object using user-provided credentials.

11. The method of claim 1 further comprising directing a temporary file cache of the operating system to storage of the client device.

12. The method of claim 11 further comprising synchronizing the temporary file cache with the persona container.

13. The method of claim 12 wherein synchronizing occurs on any one of a periodic basis and at login and logout of mobile persona environment.

14. A client device for accessing a mobile persona environment, the client device comprising
an operating system having a file system for storing persona environment data that defines the mobile persona environment, including applications, settings and user data;
mobile persona application for accessing a persona reference object to obtain a pointer to a persona container on a network connected server, the persona container having persona environment data, the mobile persona application pointing the persona environment data of the file system to the persona container of the network connected server, and the mobile persona application directing the operating system to access network connected server to activate the mobile persona environment; and
a processor and memory for executing and storing instructions of the operating system and mobile persona application.
